(19) United States
(12) Patent Application Publication
(10) Pub. No.: US 2008/0120639 A1
(43) Pub. Date: May 22, 2008

(54) System and method of providing emergency information

(75) Inventors: Edward Walter, Boerne, TX (US); Yolius Diroo, San Antonio, TX (US); Steven Michael Wollmershauser, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/603,322

(22) Filed: Nov. 21, 2006

(51) Int. Cl. H04N 5/445; H04N 7/08

(52) U.S. Cl. 725/33; 725/131; 348/473; 348/E07.024; 348/E05.096

(57) ABSTRACT

The present disclosure is directed to a system and method of providing emergency information. In a particular embodiment, the method includes receiving a video emergency alert at a set-top box device from a video head-end. The method also includes receiving a command at the set-top box device to request information related to the video emergency alert. The method also includes receiving the information at the set-top box device from the video head-end, where the information includes data retrieved via a public data network.

### FIELD OF THE DISCLOSURE

The present disclosure relates generally to providing emergency information.

### BACKGROUND

Television viewing is part of daily life for many people. As a result, television provides a source of communication for government officials and other parties to provide emergency alerts. Nonetheless, emergency alerts are typically not interactive and provide no information in addition to video content providing the video emergency alert or related news information. Moreover, because television broadcasts can cover multiple locations, such as multiple counties, some viewers may not even receive video content regarding emergency alerts that pertain to them. For example, if a tornado warning that covers a rural county is broadcast by a city news service, the corresponding television station may return to programming and leave residents in the rural county without sufficient information about the emergency. Hence, there is a need for an enhanced system and method of providing emergency information.

### BRIEF DESCRIPTION OF THE DRAWINGS

FIG. 1 is a block diagram of a particular illustrative embodiment of a system to provide emergency information;

FIG. 2 is a block diagram of a second particular illustrative embodiment of a system to provide emergency information;

FIG. 3 is a flow diagram of a particular illustrative embodiment of a method of providing emergency information;

FIG. 4 is a flow diagram of a particular illustrative embodiment of a method of receiving emergency information;

FIG. 5 is a diagram of a particular illustrative embodiment of a graphical user interface (GUI) to provide emergency information;

FIG. 6 is a diagram of a second particular illustrative embodiment of a graphical user interface (GUI) to provide emergency information;

FIG. 7 is a diagram of a third particular illustrative embodiment of a graphical user interface (GUI) to provide emergency information;

FIG. 8 is a diagram of a fourth particular illustrative embodiment of a graphical user interface (GUI) to provide emergency information;

FIG. 9 is a diagram of a fifth particular illustrative embodiment of a graphical user interface (GUI) to provide emergency information; and

FIG. 10 is a diagram of an illustrative embodiment of a general computer system.

### DETAILED DESCRIPTION OF THE DRAWINGS

The present disclosure is generally directed to a set-top box device that includes a processor and a memory device accessible to the processor. The memory device includes instructions executable by the processor to communicate with a video head-end to receive a video emergency alert. Further, the memory device includes instructions executable by the processor to communicate with a remote control device to receive a command to send information related to the video emergency alert to a display device coupled to the set-top box device. The memory device also includes instructions executable by the processor to communicate with the video head-end to receive the information, such as information that includes data retrieved via a public data network.

In another embodiment, the disclosure is directed to a method of providing emergency information that includes receiving a video emergency alert at a set-top box device from a video head-end. The method also includes receiving a command at the set-top box device to request information related to the video emergency alert. The method also includes receiving the information at the set-top box device from the video head-end, where the information includes data retrieved via a public data network.

In another embodiment, the disclosure is directed to a method of providing emergency information that includes receiving an indication of an emergency from at least one emergency alert service at a video head-end. The method also includes sending a video emergency alert to a set-top box device from the video head-end. The method also includes receiving a request from the set-top box device for information related to the video emergency alert. Further, the method includes retrieving the information via a public data network and sending the information to the set-top box device.

In another embodiment, the disclosure is directed to a computer-readable medium tangibly embodying instructions executable by a processor to communicate with a remote control device to receive a command to send information related to a video emergency alert to a display device. The instructions are also executable by the processor to send a graphical user interface (GUI) to the display device in response to the command, where the graphical user interface includes a plurality of selectable indicators of options to receive information related to the video emergency alert. The instructions are also executable by the processor to communicate with a video head-end to request information related to the video emergency alert based on a selection of at least one of the selectable indictors, where the information includes data retrieved via a public data network.

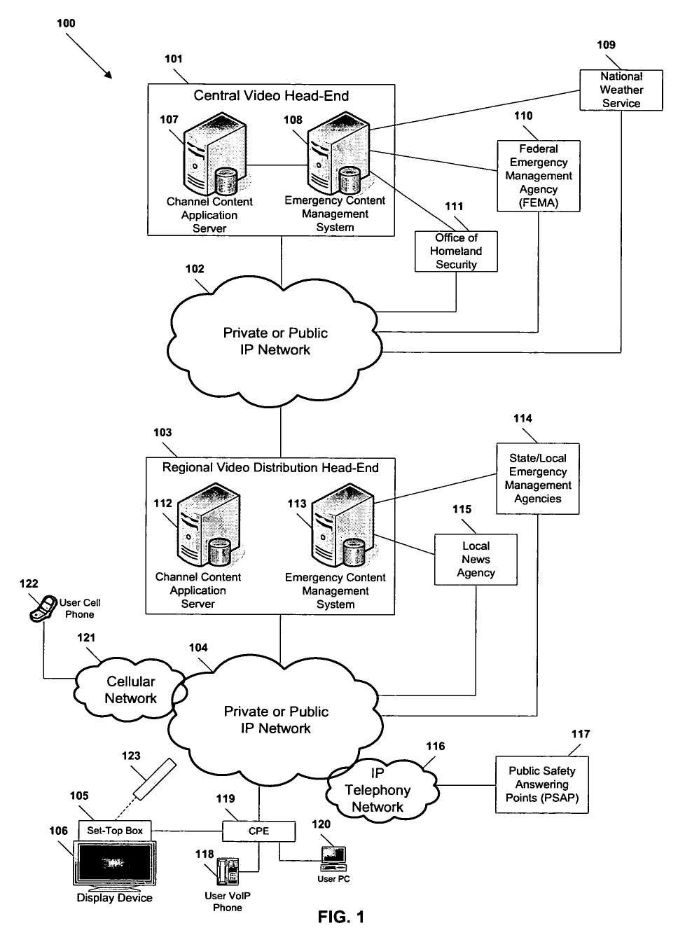

Referring to FIG. 1, an illustrative embodiment of a system to provide emergency information is illustrated and is generally designated 100. As shown, the system 100 includes a central video head-end 101 that communicates with a regional video distribution head-end 103 via a first network 102. The first network 102 can be a private or public Internet Protocol (IP) network. In addition, the regional video distribution head-end 103 communicates with a set-top box device 105 via a second network 104, which can be a private or public Internet Protocol (IP) network. In a particular embodiment, the second network 104 can be a private access network of an Internet Protocol Television (IPTV) system.

In an illustrative embodiment, the central video head-end 101 can include a central channel content application server 107 communicating with a central emergency content management system 108. The central emergency content management system 108 communicates with servers or other devices of a plurality of emergency alert services, such as the central emergency alert services 109-111. For example, the central emergency content management system 108 can communicate with national emergency alert services, such as the National Weather Service 109, the Federal Emergency Management Agency (FEMA) 110, the Office of Homeland Security 111, a national news source, another national emergency alert service, or any combination thereof. In a particular embodiment, the central emergency alert services 109-111 can communicate with the central video head-end 101 via a video connection. Further, one or more of the central emergency alert services 109-111 can communicate with the central video head-end 101 via an Internet connection.

In an illustrative embodiment, the regional video head-end 103 can include a regional channel content application server 112 communicating with a regional emergency content management system 113. The regional emergency content management system 113 communicates with servers or other devices of a plurality of regional emergency alert services, such as the state and local emergency alert services 114-115. For example, the regional emergency content management system 113 can communicate with a state or local emergency management agency 114, a local news source 115, another regional emergency alert service, or any combination thereof. In a particular embodiment, the regional emergency alert services 114-115 can communicate with the regional video head-end via a video connection. Further, one or more of the regional emergency alert services 114-115 can communicate with the regional video head-end via an Internet connection.

In a particular embodiment, the set-top box device 105 can be coupled to a display device 106, such as a television. The set-top box device 105 can communicate with the second network 104 via customer premises equipment 119, such as a residential gateway, digital subscriber line (DSL) modem, routing equipment, or any combination thereof. In an illustrative embodiment, a user phone 118, such as a Voice-over Internet Protocol (VoIP) phone, can be coupled to the customer premises equipment 119 and can communicate with an IP telephony network 116, for example, via the second network 104. The user phone 118 can be used to place and receive calls with an emergency monitoring source, such as a Public Safety Answering Point (PSAP) 117, a private emergency monitoring service, or any combination thereof. In another illustrative embodiment, a user computing device 120, such as a user personal computer, can be coupled to the customer premises equipment 119. In a further embodiment, the second network 104 can also communicate with a user cellular phone 122 via a cellular network 121.

In a particular illustrative embodiment, the central video head-end 101 can receive an indication of an emergency from one or more of the emergency alert services 109-111. The central video head-end 101 can send a video emergency alert to the set-top box device 105 via the regional video distribution head-end 103. In an illustrative embodiment, the emergency indication received from the emergency alert service(s) can include the video emergency alert. In another illustrative embodiment, the central emergency content management system 108 or the central channel content application server 107 can generate the video emergency alert based on the emergency indication.

In another particular embodiment, the regional video head-end 103 can receive an indication of an emergency from the central video head-end 101, from one or more of the regional emergency alert services 114-115, or any combination thereof. The regional video head-end 103 can send a video emergency alert to the set-top box device 105 via the second network 104. In an illustrative embodiment, the emergency indication can include the video emergency alert. In another illustrative embodiment, the regional emergency content management system 113 or the regional channel content application server 112 can generate the video emergency alert based on the emergency indication.

In an illustrative embodiment, an emergency indication can relate to a weather watch or warning, a flood watch or warning, a tide emergency, a forest or brush fire emergency, a toxic discharge emergency, an economic emergency, a terrorism emergency, a military emergency, a civil unrest emergency, an epidemic emergency, a food or water contamination emergency, a traffic emergency, a mass transit emergency, a structural damage emergency, an Amber alert, a Presidential alert, another emergency or news event, or any combination thereof.

In an illustrative embodiment, a video emergency alert can include video, audio, static or dynamic images, static or dynamic text (e.g., scrolling text), or any combination thereof. The video emergency alert can overlay or replace video content of television programming displayed at the display device 106.

In a particular embodiment, the set-top box device 105 receives a video emergency alert via the second network 104. The set-top box device 105 sends the video emergency alert to the display device 106. In an illustrative embodiment, the set-top box device 105 can receive a command to initiate an interactive session related to the video emergency alert, for example, from a remote control device 123. In another embodiment, the set-top box device 105 can automatically initiate the interactive session for every emergency alert. In yet another embodiment, the set-top box device 105 can selectively initiate the interactive session according to preferences set by a user, such as selected types of emergency alerts or selected geographic regions to which an emergency alert pertains. In a further embodiment, the user can initiate the interactive session independently of any emergency alert.

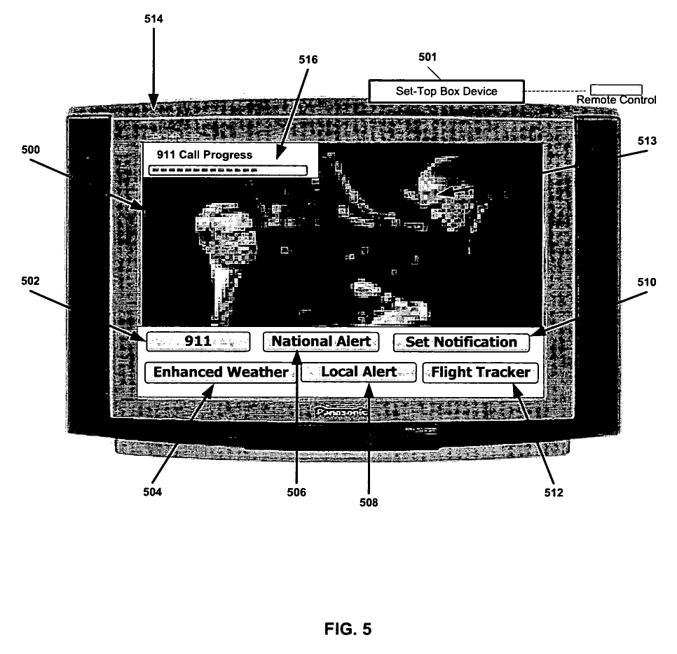

The set-top box device 105 can initiate the interactive session, for instance, by sending a graphical user interface (GUI) to the display device 106. The GUI can include a plurality of selectable indicators of options to receive information related to an emergency alert, as well as other selectable indicators. In a particular embodiment, the set-top box device 105 can select which indicators to include in the GUI based on one or more types of emergencies to which the video emergency alert pertains. A user can navigate through multiple successive pages or other displays of the GUI, for example, by using arrow keys or other keys of a remote control device 123 to highlight and select one or more of the selectable indicators. Examples of a GUI to provide emergency information are depicted in FIGS. 5-9.

In a particular embodiment, a user can select an indicator to issue a command to the set-top box device 105 to send particular information related the video emergency alert to the display device 106. The set-top box device 105 can send a request for the information to the central video head-end 101, the regional video head-end 103, or any combination thereof. The video head-end(s) receiving the request can retrieve the data related to the information via a public data network, such as the Internet, and send the information to the set-top box device 105. The data can be retrieved from one or more of the emergency alert services 109-111 and 114-115, for example, via an Internet connection; from other sources accessible via the public data network; or any combination thereof.

For example, if the video emergency alert is a weather alert, the GUI can include a weather radar indicator that is selectable by the user to issue a command to the set-top box device 105 to request video or still images of current, previous or forecast weather radar. The set-top box device 105 can send a request for radar information to the central video head-end 101, the regional video head-end 103, or any combination thereof. The video head-end(s) receiving the request can retrieve radar displays via the Internet from the national weather service 109, the local news source 115, another source accessible via the Internet, or any combination thereof. The video head-end(s) can send the radar displays to the set-top box device 105 for display at the display device 106.

The information requested via the set-top box device 105 can include video, audio, static or dynamic images, static or dynamic text, or any combination thereof. The information can overlay or replace video content of television programming displayed at the display device 106. Further, the information can overlay, replace, or alternate display with, the video emergency alert at the display device 106. In an illustrative embodiment, the information can include video or images displayed via a Picture-in-Picture (PiP) window at the display device 106 or via semi-transparent overlay of video content displayed at the display device 106.

In an illustrative, non-limiting embodiment, the set-top box device 105 can request that the information be sent by the video head-end(s) to other access points besides the set-top box device 105, such as e-mail at the user computing device 120 or text at the user cellular phone 122, according to user preferences stored at the set-top box device 105 or a selection made via the GUI. If requested, the video head-end(s) can send the information to the user computing device 120, the user cellular phone 122, other access points, or any combination thereof. In an alternative embodiment, the set-top box device 105 can receive the information from the video head-end(s) and send the information to the user computing device 120, the user cellular phone 122, other access points, or any combination thereof, for instance, via the customer premises equipment 119 and the second network 104.

In a particular embodiment, the GUI can include an emergency call indicator, such as a 911 call indicator. When a selection of the emergency call indicator is received at the set-top box device 105, the set-top box device 105 can connect the user phone 118, via the IP telephony network 116, with a public safety answering point (PSAP) 117, such as a 911 operator, or a private emergency monitoring answering point, such as a home security operator. In an illustrative embodiment, the set-top box device 105 can place the emergency call and then route the call to the user phone 118. In another embodiment, the set-top box device 105 can place a first call to the PSAP 117, for example, place a second call to the user phone 118, and bridge the first call with the second call.

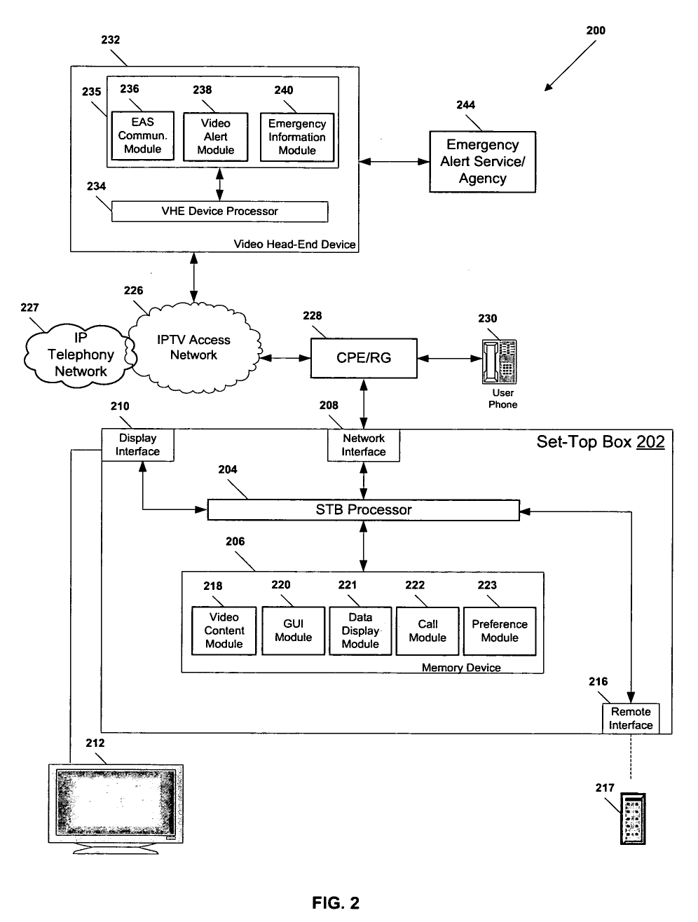

Referring to FIG. 2, a second particular embodiment of a system to communicate emergency alerts is illustrated and designated generally at 200. The system 200 includes a set-top box device 202 that communicates with a video head-end device 232 of an Internet Protocol Television (IPTV) system via an IPTV access network 226. The video head-end device 232 communicates with an emergency alert service 244 via a video connection. In a particular embodiment, the video head-end device 232 can also communicate with the emergency alert service 244 via a public data network connection, such as an Internet connection. Further, the IPTV access network 226 can communicate with an Internet Protocol (IP) telephony network 227. In addition, a user phone 230 can communicate with the set-top box device 202 and the IP telephony network 227 via customer premises equipment 228, such as a residential gateway device.

As indicated in FIG. 2, the set-top box device 202 includes a STB processor 204 and a memory device 206 accessible to the STB processor 204. In an illustrative, non-limiting embodiment, the STB processor 204 can communicate with the IPTV access network 226 via the network interface 208. In a particular embodiment, the customer premises equipment (CPE) 228 can facilitate communication between the network interface 208 and the IPTV access network 226. The CPE 228 can include a router, switch, a local area network device, a modem, such as a digital subscriber line (DSL) modem, any other suitable device for facilitating communication between the network interface 208 of the set-top box device 202 and the IPTV access network 226, or any combination thereof. Further, the CPE 228 facilitates communication between the set-top box device 202 and the user phone 230. The STB processor 204 can communicate video content and emergency alert information to a display device 212 via a display interface 210. In addition, the STB processor 204 can receive commands from a remote control device 217 via a remote interface 216.

In a particular embodiment, the memory device 206 can include a video content module 218 that is executable by the STB processor 204 to receive video content via the IPTV access network 226 and to buffer the video content before transmitting it to the display interface 210, in order to prevent underflow to the display device 212. The video content module 218 can be executable by the STB processor 204 to receive a video emergency alert from the video head-end device 232. The video emergency alert can be received in place of, separately from, or integrated with, television programming video content.

In a particular embodiment, the memory device 206 can include a GUI module 220 that is executable by the STB processor 204 to send a graphical user interface (GUI) to the display device 212. The GUI can include at least one selectable indicator of options related to emergency information, emergency calling, user preferences, or any combination thereof, and can include multiple successive pages or screens. In an illustrative, non-limiting embodiment, the GUI module 220 can be executable by the STB processor 204 to select one or more selectable indicators to be included in the GUI from a plurality of selectable indicators based, for example, on a type of video emergency alert received from the video head-end device 232. The GUI module 220 can be executable by the STB processor 204 to receive selections of indicators via the GUI, such as commands to request information related to a video emergency alert. Examples of such GUI screens are illustrated in FIGS. 5-9.

In a particular embodiment, the GUI module 220 can be executable to send the GUI to the display device 212 in response to a command from a user to initiate an interactive session related to a video emergency alert. For example, the set-top box device 202 can receive a command to initiate an interactive session by receiving a signal from the remote control device 217 indicating a selection of an emergency information key, which can be a dedicated key of the remote control device 217, a user-programmable key of the remote control device 217, or another key of the remote control device 217.

In another particular embodiment, the GUI module 220 can be executable to send the GUI to the display device 212 automatically after a video emergency alert is displayed at the display device 212. In a further particular embodiment, the GUI module 220 can be executable to send the GUI to the display device 212 according to user preferences, such as after a video emergency alert within a user-defined geographic region is displayed at the display device 212.

In a particular embodiment, the memory device 206 can include a data display module 221. The data display module 221 can be executable by the STB processor 204 to communicate with the video head-end device 232 to request and receive the information related to the video emergency alert, which includes data retrieved by the video head-end device 232 via a public data network. Further, the data display module 221 can be executable by the STB processor 204 to send the information to the display device 212.

In a particular embodiment, the memory device 206 can include a call module 222. The GUI module 220 can be executable by the STB processor 204 to include a selectable emergency call indicator with a GUI sent to the display device 212 and to receive a selection of the emergency call indicator. When such a selection is received, the call module 222 can be executable by the STB processor 204 to connect the user phone 230 with a public or private emergency monitoring service answering point, a user-defined emergency telephone number, such as a parent cellular phone, or any combination thereof, via the IP telephony network 227. In an illustrative embodiment, the set-top box device 202 can place an emergency call and route the call to the user phone 230. In another embodiment, the set-top box device 202 can place a first call to the public or private emergency monitoring service answering point, for example, place a second call to the user phone 230, and bridge the first call with the second call.

In a particular embodiment, the memory device 206 can include a preference module 223. The GUI module 220 can be executable by the STB processor 204 to include one or selectable indicators of options to input user preferences relating to, for example, criteria for video emergency alerts to be displayed at the display device 212, how alerts are to be displayed, how information related to alerts is to be displayed, when the GUI should be displayed at the display device 212, other preferences, or any combination thereof. Preferences input by a user can be stored at the memory device 205 and accessed by the STB processor 204 via the preferences module 223.

In a particular embodiment, the video head-end device 232 can include a VHE device processor 234 and a memory device 235. The memory device 235 can include an emergency alert service (EAS) communication module 236 that is executable by the VHE device processor 234 to communicate with the emergency alert service 244 to receive an indication of an emergency. In addition, the memory device 235 can include a video alert module 238 that is executable by the VHE device processor 234 to send a video emergency alert related to the indicated emergency to the set-top box device 202. The video emergency alert can be received with the emergency indication, or the video alert module 238 can be executable by the VHE device processor 234 to generate the video emergency alert based on the emergency indication received from the emergency alert service 244.

In a particular embodiment, the memory device 235 can include an emergency information module 240 that is executable by the VHE device processor 234 to receive a request from the set-top box device 202 for information related to a video emergency alert. Further, the emergency information module 240 is executable by the VHE device processor 234 to retrieve the information by retrieving data from a public data network, such as the Internet. In an illustrative embodiment, the emergency information module 240 can be executable by the VHE device processor 234 to retrieve articles and other information from the emergency alert service 244 via an Internet connection, from other sources accessible via the Internet, or any combination thereof.

In an illustrative embodiment, the various modules 218-223 and 236-240 can include logic, hardware, computer instructions, or any combination thereof.

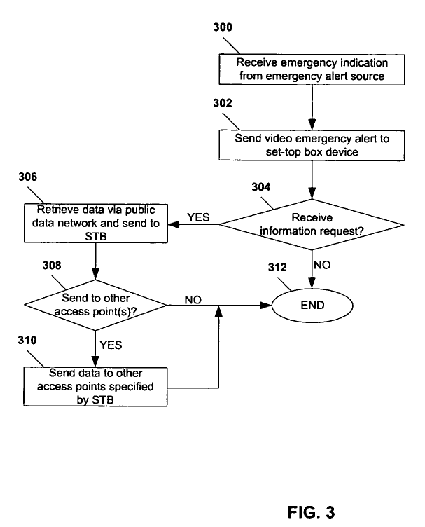

Referring to FIG. 3, a particular illustrative embodiment of a method of providing emergency information is illustrated. At block 300, a video head-end of a video distribution system receives an indication of an emergency from an emergency alert service via a video connection. The video head-end can be a central video head-end, a regional video head-end, or a sub-regional video head-end. Moving to block 302, the video head-end sends a video emergency alert to a set-top box device. In an illustrative embodiment, the video head-end can send the video emergency alert to a plurality of set-top box devices that includes the set-top box device, such as a multicast group, via a private access network of an Internet Protocol Television (IPTV) system. In a particular embodiment, the emergency indication received at the video head-end can include the video emergency alert. In another embodiment, the video head-end can generate the video emergency alert based on the emergency indication.

Proceeding to decision node 304, the video head-end determines whether it has received a request for information related to the video emergency alert from the set-top box device. If the video head-end determines that it has not received such a request, the method terminates at 312. Conversely, if the video head-end determines that it has received a request for information related to the video emergency alert, the method continues to block 306, and the video head-end retrieves the information and sends the information to the set-top box device. The information includes data retrieved by the video head-end via a public data network, such as the Internet. The data can be retrieved from the emergency alert service via an Internet connection, from another source accessible via the Internet, or any combination thereof.

Proceeding to decision node 308, the video head-end determines whether the request for information received from the set-top box device indicates that the information should be sent to other access points, such as a user computing device or a user mobile phone. If the video head-end determines that the request does not indicate that the information should be sent to one or more other access points, the method terminates at 312. Conversely, if the video head-end determines that the request indicates that the information should be sent to one or more other access points, the video head-end device can send the information to such access points at block 310. The method terminates at 312.

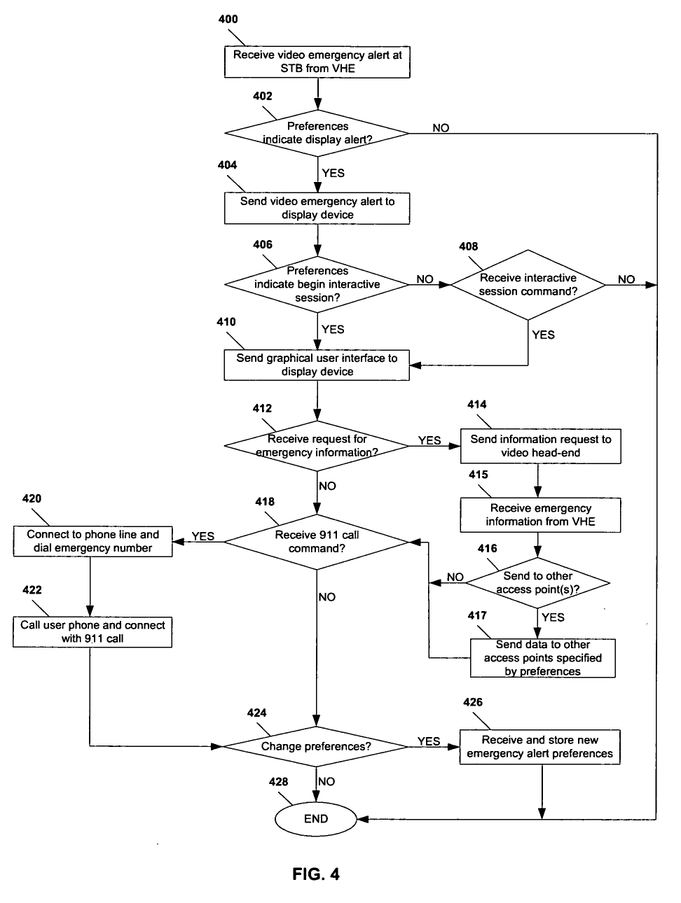

Referring to FIG. 4, a particular illustrative embodiment of a method of receiving emergency information is illustrated. At block 400, a set-top box receives a video emergency alert from a video head-end. Moving to decision node 402, in a particular embodiment, the set-top box device determines whether user preferences indicate that the video emergency alert should be displayed. For example, user preferences stored at the set-top box device can indicate that the video emergency alert is to be sent to a display device only if it pertains to an emergency within a user-defined type or geographic region. If the set-top box device determines that the video emergency alert should not be displayed, the method terminates at 428. On the other hand, if the set-top box device determines that the video emergency alert should be displayed, the method moves to block 404, and the set-top box sends the video emergency alert to a display device coupled to the set-top box device.

Proceeding to decision node 406, in a particular embodiment, the set-top box device determines whether user preferences indicate that an interactive session related to the video emergency alert should be initiated. For example, user preferences stored at the set-top box device can indicate that an interactive session should always be initiated after an video emergency alert is sent to the display device; should be initiated only if the video emergency alert pertains to a particular type of emergency or to an emergency within a user-defined geographic region; or should be initiated only under other circumstances. If the set-top box device determines that user preferences indicate that an interactive session should be initiated, the method continues to block 410. On the other hand, if the set-top box device determines that user preferences do not indicate that an interactive session should be initiated, the method moves to decision node 408, and the set-top box determines whether it has received a command, for example, from a remote control device communicating with the set-top box device, to initiate an interactive session. If the set-top box device does not receive such a command, the method terminates at 428. Conversely, if the set-top box device receives a command to initiate an interactive session, the method proceeds to block 410.

At block 410, in a particular embodiment, the set-top box device sends a graphical user interface (GUI) to the display device. The graphical user interface includes one or more selectable indicators. The selectable indicator(s) can relate to options to receive emergency information, to set user preferences, to make an emergency call, or any combination thereof. In an illustrative embodiment, the set-top box can select the indicator(s) to include in the GUI from a plurality of indicators based on the video emergency alert, other criteria, or any combination thereof.

Proceeding to decision node 412, the set-top box device determines whether it has received a command to request information related to the video emergency alert. If the set-top box device determines that it has not received a command to display information related to the video emergency alert, the method continues to decision node 418. Whereas, if the set-top box determines that it has received such a command, the method moves to block 414, and the set-top box sends a request for the information to the video head-end. Advancing to block 415, the set-top box device receives the information from the video head-end. The information includes data retrieved by the video head-end via a public data network, such as the Internet.

Proceeding to decision node 416, the set-top box device determines whether user preferences, or a GUI selection, indicate that the information should be sent to other access points, such as a user computing device or a user mobile phone. If the set-top box device determines that the information should not be sent to one or more other access points, the method proceeds to decision node 418. Conversely, if the set-top box device determines that user preferences indicate that the information should be sent to one or more other access points, the set-top box device can send the information to such access points, at block 417. The method continues to decision node 418.

At decision node 418, in an illustrative embodiment, the set-top box device can determine whether it has received a command to place an emergency call, such as a 911 call. For example, the graphical user interface sent to the display device at block 410 can include a selectable indicator of an option to place an emergency call via the set-top box device. If the set-top box device determines that it has not received a command to place an emergency call, the method can proceed to decision node 424. On the other hand, if the set-top box device has received a command to place an emergency call, the method moves to block 420, and the set-top box device places a first call to a telephone number of a public or private emergency monitoring service answering point. In an illustrative, non-limiting embodiment, the method proceeds to block 422, and the set-top box device can place a second call to a user phone, such as a Voice-over Internet Protocol (VoIP) phone, and can bridge the first call with the second call. The method then advances to decision node 424.

At decision node 424, in an illustrative embodiment, the set-top box device can determine whether it has received a command via the graphical user interface to change user preferences related to display of video emergency alerts, display of information, custom alert zones, notifications sent to other access points, such as mobile phones or e-mail, or other user preferences. If the set-top box device has received a command to change user preferences, the set-top box device can receive and store new preferences at block 426. The method terminates at 428.

In a particular embodiment, the steps of the methods described herein can be executed in the order shown by the figures. In alternative embodiments, some steps can be executed simultaneously or in alternative sequences. For example, the set-top box device can receive commands to request information, make an emergency call, or change user preferences, in any order.

Referring to FIG. 5, a particular illustrative embodiment of a graphical user interface (GUI) to provide emergency information is illustrated. In the embodiment shown, the GUI 500 includes a plurality of selectable indicators 502-512. For example, the GUI 500 includes a 911 call indicator 502 that can be selected to instruct a set-top box device 501 to initiate an emergency call. In a particular embodiment, a 911 call progress indicator 516 can be displayed when a command to initiate an emergency call is received. Further, the GUI 500 includes an enhanced weather indicator 504 that can be selected to instruct the set-top box device 501 to request weather information, such as information related to a video weather alert. For example, current radar displays, past radar displays, future radar displays, forecast information, precipitation amounts and other current or past weather statistics, lightning strike information, other weather information, or any combination thereof, can be offered or displayed when the enhanced weather indicator 504 is selected.

As illustrated, the GUI 500 can include a national alert indicator 506 that can be selected to instruct the set-top box device 501 to send information related to a national emergency alert to the display device 514. For example, video, audio, still images, articles or other text information, or any combination thereof, related to a national emergency alert, such as an Amber alert, a terrorism alert, or a Presidential alert, can be displayed at the display device 514 when the national alert indicator 506 is selected. In addition, the GUI 500 can include a local alert indicator 508 that can be selected to instruct the set-top box device 501 to request information related to a local emergency alert, such as a statewide or citywide alert. For example, video, audio, still images, articles or other text information, or any combination thereof, related to a local emergency alert, can be displayed at the display device 514 when the local alert indicator 508 is selected.

The GUI 500 can include a set notification indicator 510 that can be selected to instruct the set-top box device 501 to receive inputs of user preferences related to video emergency alerts. For example, a user can set preferences related to which video emergency alerts, if any, are displayed at the display device 514 (e.g., based on type, location, severity, etc.); how video emergency alerts and information are displayed at the display device 514; whether information is also sent to other access points; other preferences; or any combination thereof.

In a particular embodiment, the GUI 500 can include a transportation tracking indicator, such as a flight tracking indicator 512. The flight tracking indicator 512 can be selected to instruct the set-top box device 501 to request flight paths, delays, cancellations, or other information for all flights or a specific current or future flight, for instance, flights that might be impacted by a weather emergency.

The information displayed by the set-top box in response to a selection of one or more of the indicators 502-512 includes information requested from a video head-end and retrieved via a public data network.

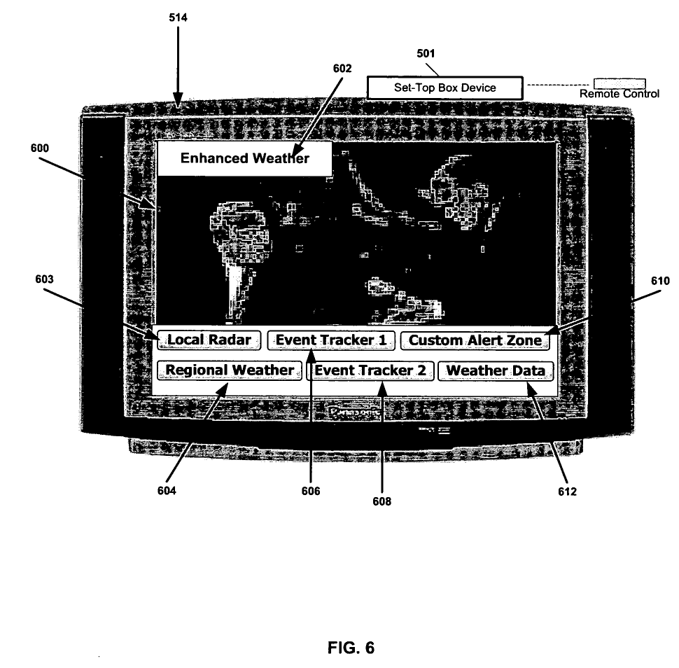

Referring to FIG. 6, a second particular illustrative embodiment of a graphical user interface (GUI) to provide emergency information is illustrated. In the embodiment shown, the GUI 600 includes an identification 602 of a previously selected indicator, such as the enhanced weather indicator 502 illustrated in FIG. 5. Further, the GUI 600 includes a plurality of selectable indicators 603-612. For example, the GUI 600 can include a local radar indicator 603 that can be selected to instruct a set-top box device 501 to request still or animated past radar images, current radar images, future radar images, or any combination thereof.

In a particular embodiment, the GUI 600 can include a regional weather indicator 604 that can be selected to instruct the set-top box device 501 to request regional weather information, such as regional radar displays, forecast information, precipitation amounts and other current or past weather statistics, lightning strike information, other weather information, or any combination thereof.

As illustrated, the GUI 600 can include a first event tracker indicator 606 and a second event tracker indicator 608 that can be selected to instruct the set-top box device 501 to request updated information related to particular weather emergencies, for example, on a periodic basis. In addition, the GUI 600 can include a custom alert zone indicator 608 that can be selected to instruct the set-top box device 501 to only send video emergency alerts pertaining to weather to the display device, when a weather emergency is within a certain geographic area, such as within a certain number of miles around the user's home, within a certain number of miles around a relative's home, within a certain number of miles around a school or business, within another geographic area, or any combination thereof. Further, the GUI 600 can include a weather data indicator 612 that can be selected to instruct the set-top box device 501 to request other weather information.

The information displayed by the set-top box in response to a selection of one or more of the indicators 603-612 includes information requested from a video head-end and retrieved via a public data network.

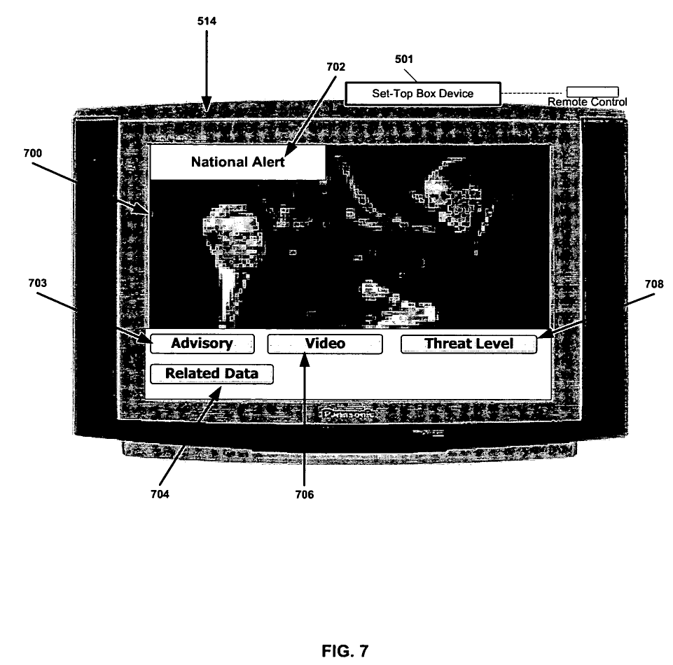

Referring to FIG. 7, a third particular illustrative embodiment of a graphical user interface (GUI) to provide emergency information is illustrated. In the embodiment shown, the GUI 700 includes an identification 702 of a previously selected indicator, such as the national alert indicator 506 or local alert indicator 508 illustrated in FIG. 5. Further, the GUI 700 includes a plurality of selectable indicators 703-708. For example, the GUI 700 can include an advisory indicator 703 that can be selected to instruct a set-top box device 501 to request information related to the alert, such as safety precaution instructions, evacuation instructions, other advisory information, or any combination thereof.

In a particular embodiment, the GUI 700 can include a video indicator 704 that can be selected to instruct the set-top box device 501 to send video content related to the national or local alert to the display device 514. Further, GUI 700 can include a threat level indicator 706 that can be selected to instruct the set-top box device 501 to request information related to a severity of an emergency, such as a storm category (e.g., F-3 tornado, Cat-5 hurricane, Red Flag burn ban, ozone action level, water rationing level, etc.), a terror threat level, or other emergency severity information. In addition, the GUI 700 can include a related data indicator 708 that can be selected to send other information related to a national or local alert to the display device 514.

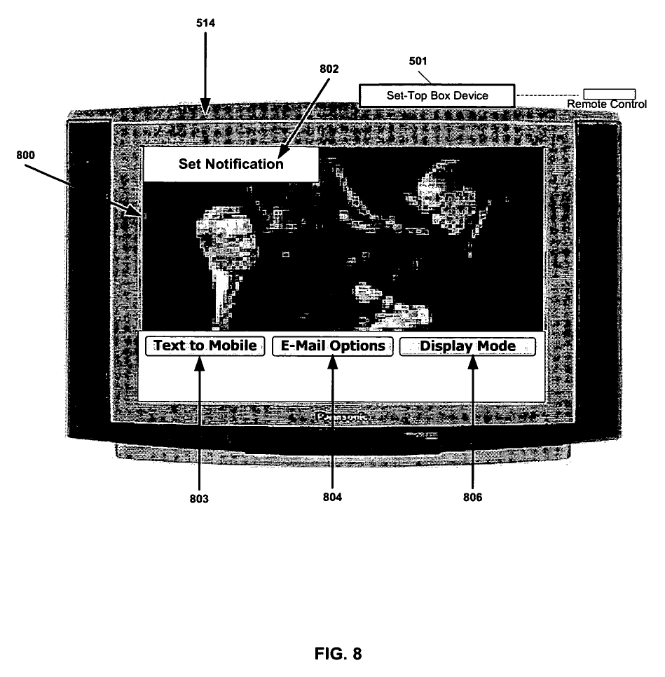

Referring to FIG. 8, a fourth particular illustrative embodiment of a graphical user interface (GUI) to provide emergency information is illustrated. In the embodiment shown, the GUI 800 includes an identification 802 of a previously selected indicator, such as the set notification indicator 510 illustrated in FIG. 5. Further, the GUI 800 includes a plurality of selectable indicators 803-805. For example, the GUI 800 can include a set text to mobile indicator 803 that can be selected to instruct a set-top box device 501 to send information related to a video emergency alert to a mobile phone or other portable device, or to instruct the set-top box device to request that such information be sent to the portable device by a video head-end that receives the information.

In addition, the GUI 800 can include an e-mail options indicator 804 that can be selected to instruct a set-top box device 501 to send information related to a video emergency alert to an e-mail account, or to instruct the set-top box device to request that such information be sent to the an e-mail account by a video head-end that receives the information. Further, the GUI 800 can include a display mode indicator 805 that can be selected to input user preferences related to how video emergency alerts and emergency information are displayed at the display device 514 (e.g., Picture-in-Picture, in place of video content 513, overlaying video content 513, semi-transparently overlaying video content 513, scrolling left to right, moving bottom to top within a box or window, etc.).

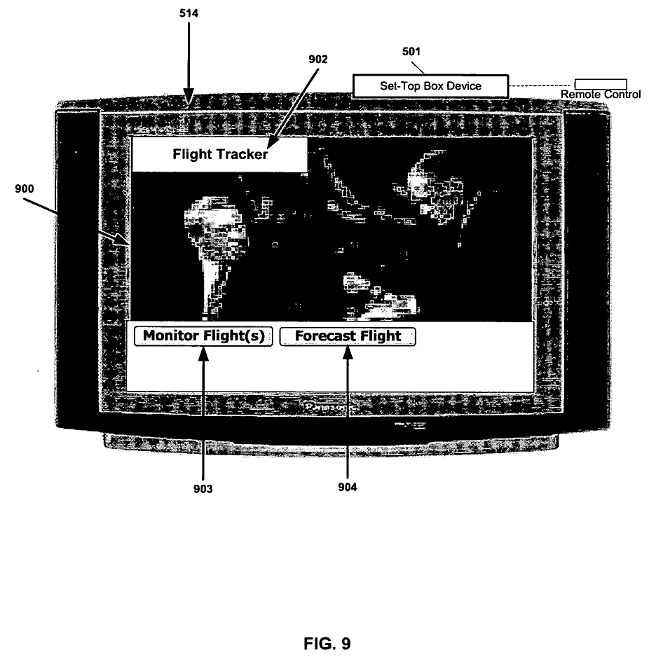

Referring to FIG. 9, a fifth particular illustrative embodiment of a graphical user interface (GUI) to provide emergency information is illustrated. In the embodiment shown, the GUI 900 includes an identification 902 of a previously selected indicator, such as the flight tracker indicator 512 illustrated in FIG. 5. Further, the GUI 900 includes a plurality of selectable indicators 903-904. For example, the GUI 900 can include a monitor flight(s) indicator 903 that can be selected to instruct a set-top box device 501 to request information related to one or more current flights, such as flight path, flight schedule, flight delay, flight cancellation, other flight information, or any combination thereof.

In addition, the GUI 900 can include a forecast flight indicator 904 that can be selected to instruct the set-top box device 501 to request flight forecast information, such as a projected flight path affected by weather, other flight forecast information, or any combination thereof.

In conjunction with the configuration of structure described herein, the system and method disclosed provide emergency information. In a particular illustrative embodiment, a video head-end can receive an indication of an emergency from one or more emergency alert services. The video head-end sends a video emergency alert to the set-top box device. In an illustrative embodiment, the emergency indication received from the emergency alert service(s) can include the video emergency alert. In another illustrative embodiment, the video head-end can generate the video emergency alert based on the emergency indication.

In a particular embodiment, the set-top box device receives the video emergency alert. The set-top box device sends the video emergency alert to a display device coupled to the set-top box device. In an illustrative embodiment, the set-top box device can initiate an interactive session related to the video emergency alert. The set-top box device can initiate the interactive session, for instance, by sending a graphical user interface (GUI) to the display device. The GUI can include a plurality of selectable indicators of options to receive information related to an emergency alert, as well as other selectable indicators.

In a particular embodiment, a user can select an indicator to issue a command to the set-top box device to request particular information related the video emergency alert. The set-top box device can send a request for the information to the video head-end, and the video head-end can retrieve data related to the information via a public data network, such as the Internet. The video head-end sends the information to the set-top box device.

In a particular embodiment, the GUI can include an emergency call indicator, such as a 911 call indicator. When a selection of the emergency call indicator is received at the set-top box device, the set-top box device can connect a user phone, via the IP telephony network, with a public safety answering point (PSAP), such as a 911 operator, or a private emergency monitoring answering point, such as a home security operator. In an illustrative embodiment, the set-top box device can place the emergency call and then route the call to the user phone. In another embodiment, the set-top box device can place a first call to the PSAP, for example, place a second call to the user phone, and bridge the first call with the second call.

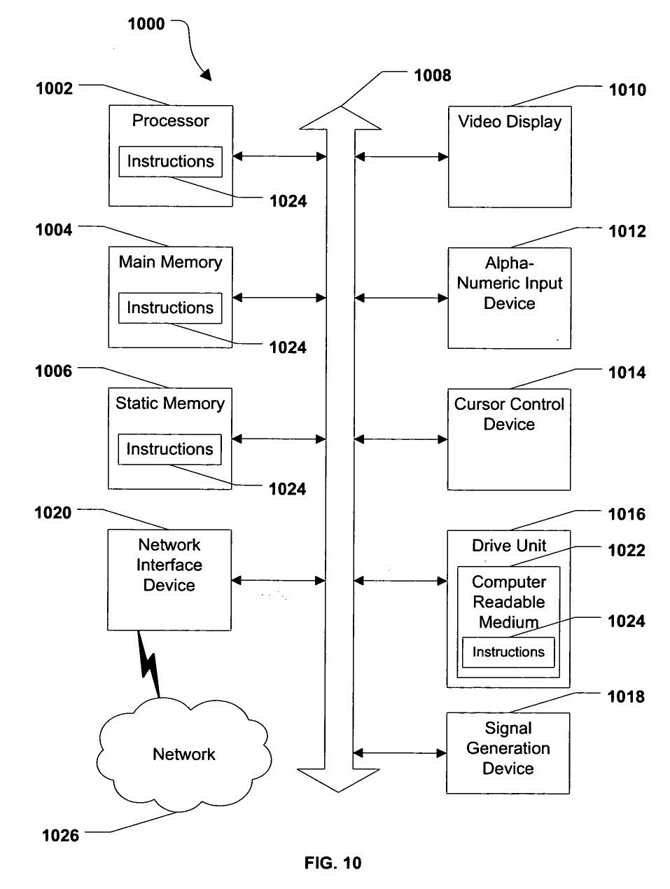

Referring to FIG. 10, an illustrative embodiment of a general computer system is shown and is designated 1000. The computer system 1000 can include a set of instructions that can be executed to cause the computer system 1000 to perform any one or more of the methods or computer based functions disclosed herein. The computer system 1000, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a channel content server, emergency content management server, multicast server, video content server, other video head-end device, or a set-top box device. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics-processing unit (GPU), or both. Moreover, the computer system 1000 can include a main memory 1004 and a static memory 1006 that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. Further, the computer system 1000 can include a wireless input device 1015, e.g., a remote control device. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of receiving emergency information, the method comprising:
receiving a video emergency alert at a set-top box device from a video head-end;
receiving a command at the set-top box device to request information related to the video emergency alert; and
receiving the information at the set-top box device from the video head-end, wherein the information includes data retrieved via a public data network.

2. The method of claim 1, further comprising receiving a request at the set-top box device to initiate an interactive session related to the video emergency alert.

3. The method of claim 2, further comprising sending a graphical user interface to the display device, wherein the graphical user interface includes one or more selectable indicators of options to receive information related to the video emergency alert.

4. The method of claim 3, wherein each of the one or more indicators is related to an option to receive a particular type of emergency information.

5. The method of claim 4, wherein each particular type of emergency information includes weather information, weather radar images, weather radar video, national emergency information, national emergency video, national threat level information, state emergency information, state emergency video, state threat level information, local emergency information, local emergency video, local threat level information, emergency event tracking information, or flight information.

6. The method of claim 4, further comprising selecting the one or more indicators from a plurality of indicators based at least partially on a type of emergency indicated by the video emergency alert.

7. The method of claim 3, wherein the graphical user interface includes a selectable indicator of an option to initiate an emergency call.

8. The method of claim 7, further comprising:
placing a first call from the set-top box device to a Public Safety Answering Point (PSAP) in response to a selection of the indicator of the option to initiate an emergency call; and
placing a second call to a user phone; and
bridging the first call with the second call.

9. A method of providing emergency information, the method comprising:
receiving an indication of an emergency from at least one emergency alert service at a video head-end;
sending a video emergency alert to a set-top box device from the video head-end;
receiving a request from the set-top box device for information related to the video emergency alert;
retrieving the information via a public data network; and
sending the information to the set-top box device.

10. The method of claim 9, wherein the indication of the emergency is received via a video connection between the video head-end and the at least one emergency alert service.

11. The method of claim 10, wherein the information is received via an Internet connection between the video head-end and the at least one emergency alert service, between the video head-end and a source other than the at least one emergency alert service, or any combination thereof.

12. The method of claim 9, wherein the at least one emergency alert service includes a television news station, a federal emergency agency, a state emergency agency, a local emergency agency, a weather service, or any combination thereof.

13. The method of claim 9, wherein the indication of the emergency includes the video emergency alert.

14. The method of claim 9, wherein the video head-end generates the video emergency alert based on the indication of the emergency.

15. The method of claim 9, further comprising sending the information to a portable device, an e-mail account, another access point, or any combination thereof, wherein the request received from the set-top box device indicates that the information is to be sent to the portable device, the e-mail account, the other access point, or any combination thereof.

16. A set-top box device, comprising:
a processor and a memory device accessible to the processor, wherein the memory device includes instructions executable by the processor to:
communicate with a video head-end to receive a video emergency alert;
communicate with a remote control device to receive a command to request information related to the video emergency alert; and
communicate with the video head-end to receive the information, wherein the information includes data retrieved via a public data network.

17. The set-top box device of claim 16, wherein the memory device includes instructions executable by the processor to send a request for the information to the video head-end via a private access network of an Internet Protocol Television (IPTV) system, wherein the video emergency alert and the information are received via the private access network.

18. The set-top box device of claim 16, wherein the memory device includes instructions executable by the processor to communicate with the remote control device to receive a request to initiate an interactive session, the request including a signal indicating a selection of an emergency information key of the remote control device.

19. The set-top box device of claim 18, wherein:
the memory device includes instructions executable by the processor to send a graphical user interface to the display device in response to the request to initiate the interactive session, the graphical user interface responsive to the remote control device; and
the graphical user interface includes a plurality of selectable indicators of options to receive information related to the video emergency alert.

20. The set-top box device of claim 19, further comprising at least one telephone line interface, wherein the graphical user interface includes a selectable indicator of an option to initiate an emergency call to a public safety answering point, a private emergency monitoring service answering point, a parent cellular phone, or a user-defined emergency telephone number.

21. The set-top box device of claim 20, wherein the memory device includes instructions executable by the processor to:
place a first call from the set-top box device to a Public Safety Answering Point (PSAP) in response to a selection of the indicator of the option to initiate an emergency call;
place a second call to a user phone; and
bridge the first call with the second call.

22. The set-top box device of claim 19, wherein the graphical user interface includes a selectable indicator of an option to input user preferences including criteria for sending a video emergency alert to the display device, criteria for automatically initiating an interactive session related to a video emergency alert, a format to display video emergency alerts, a format to display information related to video emergency alerts, whether to send information related to video emergency alerts to other access points, other preferences, or any combination thereof.

23. The set-top box device of claim 16, wherein the video emergency alert relates to a weather watch or warning, a flood watch or warning, a tide emergency, a forest or brush fire emergency, a toxic discharge emergency, an economic emergency, a terrorism emergency, a military emergency, a civil unrest emergency, an epidemic emergency, a food or water contamination emergency, a traffic emergency, a mass transit emergency, a structural damage emergency, an Amber alert, a Presidential alert, another emergency, another news event, or any combination thereof.

24. A computer-readable medium tangibly embodying a set of instructions that are executable by a processor to:
communicate with a remote control device to receive a command to send information related to a video emergency alert to a display device;
send a graphical user interface (GUI) to the display device in response to the command, wherein the graphical user interface includes a plurality of selectable indicators of options to receive information related to the video emergency alert; and
communicate with a video head-end to request information related to the video emergency alert based on a selection of at least one of the selectable indictors, wherein the information includes data retrieved via a public data network.

25. The computer-readable medium of claim 24, wherein the GUI includes a call 911 indicator and further comprising instructions to send a 911 call progress indicator to the display device in response to a selection of the call 911 indicator.

26. The computer-readable medium of claim 24, wherein the GUI includes a notification options indicator and wherein the computer-readable medium includes instructions to store at least one on-screen emergency notification preferences, at least one remote emergency notification preferences, or any combination thereof, after the notification options indicator is selected via the GUI.

27. The computer-readable medium of claim 26, further comprising instructions to send the information, a text emergency alert, or any combination thereof, to a mobile phone based on the at least one remote emergency notification preference.

28. The computer-readable medium of claim 26, further comprising instructions to send the information, a text emergency alert, or any combination thereof, to an e-mail address based on the at least one remote emergency notification preference.

29. The computer-readable medium of claim 24, wherein the GUI includes a custom alert zone indicator and further comprising instructions to store data indicating a user-defined geographic region when the custom alert zone indicator is selected and to not send the video emergency alert to the display device when the video emergency alert is related to an emergency outside the user-defined geographic region.
